(19) United States
(12) Patent Application Publication
(10) Pub. No.: US 2009/0242141 A1
(43) Pub. Date: Oct. 1, 2009

(54) MOSQUITO CURTAIN FOR ROLLING SHUTTERS OR WINDOW OPENINGS

(76) Inventors: Antonio Trotta, Borgo Grappa (IT); Giovanni Albanese, Aprilia (IT)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/280,155

(22) PCT Filed: Feb. 19, 2007
(86) PCT No.: PCT/IT2007/000111

§ 371 Date: Dec. 15, 2008

(30) Foreign Application Priority Data
Feb. 20, 2006 (IT) RM2006A000082
Aug. 2, 2006 (IT) RM2006A000412

(51) Int. Cl. E06B 9/52

(52) U.S. Cl. 160/84.02

(57) ABSTRACT

Mosquito curtain for rolling shutters, comprising an upper section bar (10) and a lower section bar (20) and a net (30) fixed with its vertical ends to respective internal bases (12,22) of said upper section bar (10) and said lower section bar (20), in such a way that when said upper section bar (10) and said lower section bar (20) are brought in contact vertically, the net (30) is enclosed in a room delimited by them, the mosquito curtain comprising further means of reversible connection (50,51,40,) of the upper section bar (10) with the lower section bar (20), the upper section bar (10) being fixable to the lower end of the rolling shutter (70), so as to follow the movement of the rolling shutter when this is moved,
the mosquito curtain being characterised in that:
   the net (30) is a pleated net;
   it comprises one or more guide threads (31) for the traverse of the net (30) in its extension or contraction as a consequence of the relative approaching of the upper section bar (10) and the lower section bar (20):
   said one or more threads (31,310) pass through the pleated net and are fixed on an internal base (22) of the lower section bar (20);
   it comprises a winding mechanism, placed in a portion (52) of the upper section bar (10), for said one or more guide threads (31,310), which wind up on an only roll equipped with a spring.

The present invention concerns a vertical mosquito for rolling shutters or window openings.

More in detail, the invention concerns an automatic mosquito curtain that can be fixed easily at the end of a rolling shutters or a window openings and that can be opened or closed on command in a simple and effective way.

Mosquito for windows are known of various type, in particular mosquitoes with frame to be applied each time to windows. Such traditional devices require a specific installation, or they have to be removed seasonally or still they are of non-simple use.

It remains therefore the necessity of a mosquito curtain that can be installed easily on existing shutters or window openings, without the need of frame, and that can be opened or closed on command in an easy and effective way.

It is object of the present invention to provide a mosquito curtain for rolling shutters that solves the problem and overcomes the disadvantages of the traditional mosquito curtains.

It is subject-matter of the present invention a Mosquito curtain for rolling shutters, characterised in that it comprises an upper section bar and a lower section bar and a net fixed with its vertical ends to respective internal bases of said upper section bar and said lower section bar, in such a way that when said upper section bar and said lower section bar are brought in contact vertically, the net is enclosed in a room delimited by them, the mosquito curtain comprising further means of reversible connection of the upper section bar with the lower section bar, the upper section bar being fixable to the lower end of the rolling shutter, so as to follow the movement of the rolling shutter when this is moved.

Preferably according to the invention, the net is a pleated net, preferably of 12 mm.

Preferably according to the invention, the mosquito curtain comprises one or more guide threads for the traverse of the net in its extension or contraction as a consequence of the relative approaching of the upper section bar and the lower section bar.

Preferably according to the invention, said one or more guide threads are fixed to an internal base of the lower section bar and come out laterally from the upper section bar where they are returned by a return elastic means.

Preferably according to the invention, the lower part of said lower section bar comprises at least a housing for at least a respective weight.

Preferably according to the invention, said means of reversible connection of the upper section bar with the lower section bar comprise a male element connected laterally to one of the two section bars, vertically insertable in a corresponding female device connected on the same side laterally to the other section bar.

Preferably according to the invention, said means of reversible connection are such that, by making the lower section bar beat on the ground a first time, said male element is locked in said corresponding female element, the unlocking being obtained by making the lower section bar beat on the ground again.

Preferably according to the invention, a rubber base is fixed to the lower end, which is turned to ground, of the lower section bar.

Preferably according to the invention, the part of said means of reversible connection provided laterally on the upper section bar comprise motorised return and release means of said one or more guide threads, which are fixed on an internal base of the lower section bar and come out laterally from the upper section bar.

Preferably according to the invention, said motorised return and release means comprise an electric motor, in particular that can be operated remotely.

Preferably according to the invention, the upper section bar is fixable to the lower end of the mosquito curtain by means of a screw/nut system applied to the stop of the rolling shutter.

Preferably according to the invention, the upper end of the upper section bar presents a hooking element that can hook the corresponding hook of the rolling shutter that normally serves for joining two elements of the rolling shutter, said rolling shutter being fixed to the upper section bar by inserting it horizontally along said hooking element.

Preferably according to the invention, said one or more guide threads roll up on an only roll in a portion of the upper section bar.

It is further subject-matter of the invention a mosquito curtain vertically expansible for window opening or door or the like, characterised in that it comprises an upper section bar and a lower section bar and a net fixed with its vertical ends to respective internal bases of said upper section bar and said lower section bar, so that when said upper section bar and said lower section bar are brought in contact vertically, the net is enclosed in a room delimited by them, the mosquito curtain comprising further means of reversible connection of the upper section bar with the lower section bar, the upper section bar being fixable to fixing means to the upper wall of the window opening, laterally to said lower section bar and/or upper section bar being provided one or more lateral guide means of the section bar suited to slide into corresponding vertical sliding guides fixed to window opening.

Preferably according to the invention, said at least a respective lateral guide element is part of a lateral “plug” of the lower section bar and/or of the upper section bar.

Preferably according to the invention, the net is a pleated net, preferably of 14 mm.

Preferably according to the invention, the mosquito curtain comprises more guide threads for the run of the net in its extension or contraction as a consequence of the relative approach motion of the upper section bar and the lower section bar.

Preferably according to the invention, said more guide threads are fixed on an internal base of the lower section bar and comes out laterally from the upper section bar where they are returned by a winding mechanism.

Preferably according to the invention, said lower section bar comprises at least a housing for at least a respective weight.

Preferably according to the invention, said more guide threads roll up all on an only roll in a portion of the upper section bar.

Preferably according to the invention, said winding mechanism is a return spring.

Preferably according to the invention, said winding mechanism is a motorised mechanism.

Preferably according to the invention, said means of reversible connection of the upper section bar with the lower section bar comprise a male element connected laterally to one of the two section bars, vertically insertable in a corresponding female device connected on the same side laterally to the other section bar.

Preferably according to the invention, said means of reversible connection are such that, by making the lower section bar beat on the ground a first time, said male element is locked into said corresponding female element, the unlocking being obtained by making the lower section bar beat on the ground again.

Preferably according to the invention, a rubber base is fixed at the end of the lower section bar which is turned to the ground.

Preferably according to the invention, the net is a pleated net.

The invention will be now described, by way of illustration and not by way of limitation, by particularly referring to the drawings of the enclosed Figures, in which:

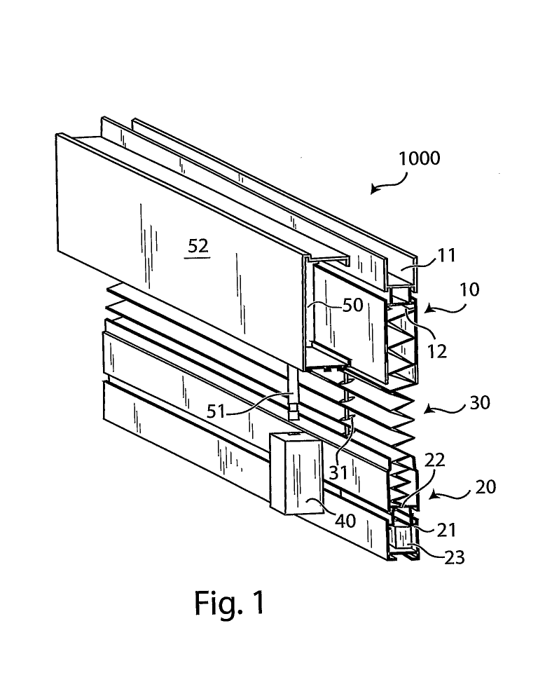

FIG. 1 shows a perspective view of a first embodiment of the device according to the invention;

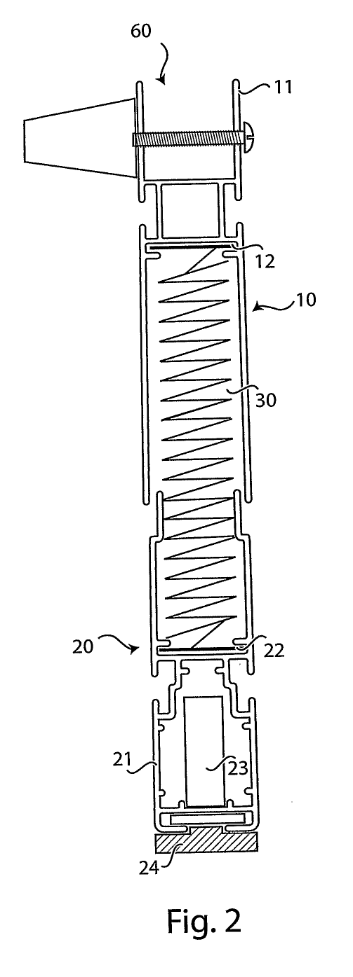

FIG. 2 shows a sectional view of a part of the embodiment of the device according to FIG. 1;

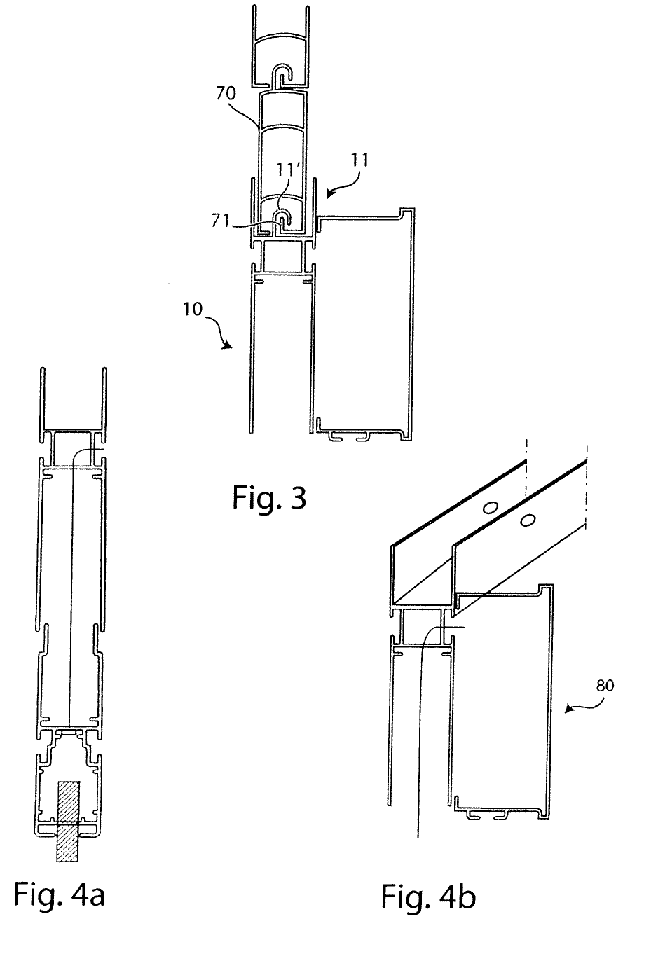

FIG. 3 shows an example of hooking of the device according to the invention to a rolling shutter for windows;

FIGS. 4a and 4b show a variation of a detail of the first embodiment of the device according to the invention;

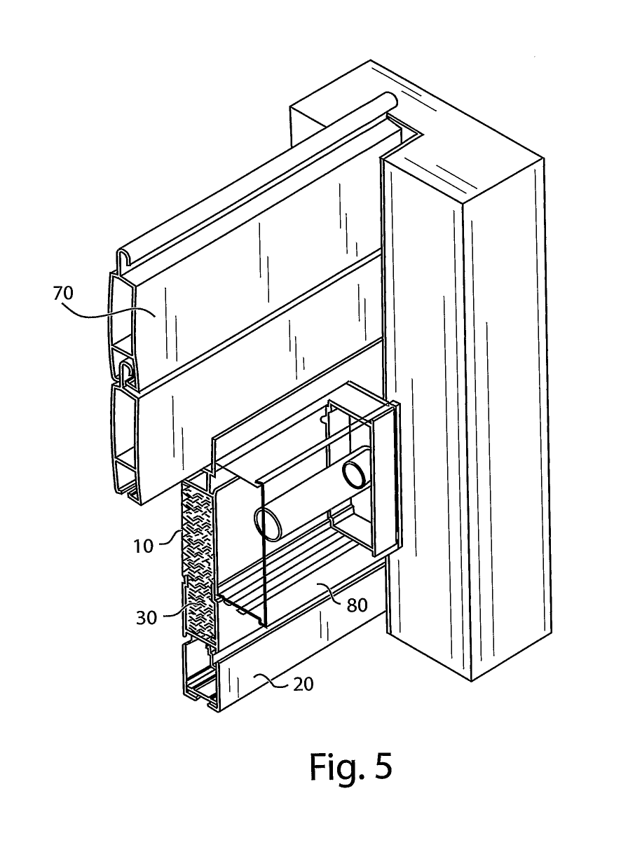

FIG. 5 shows a partial perspective view of the first embodiment according to the invention applied to a rolling shutter;

FIG. 6 shows a perspective view of a variation of the first embodiment according to the invention;

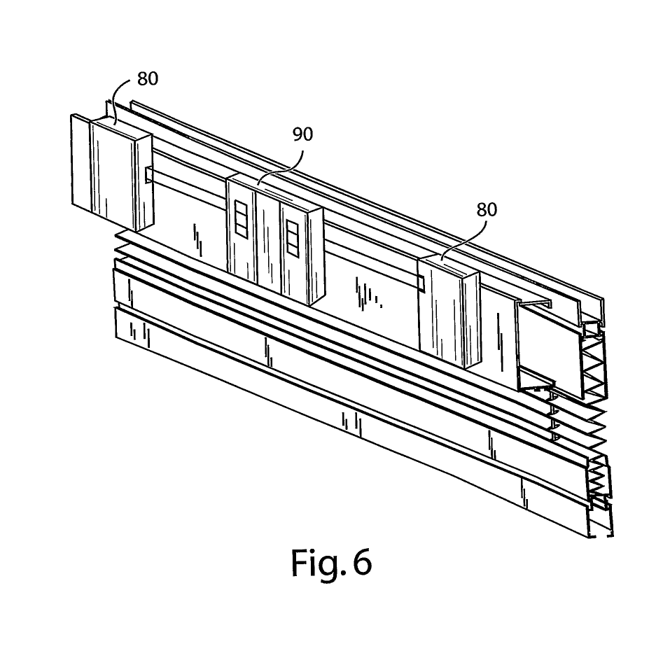

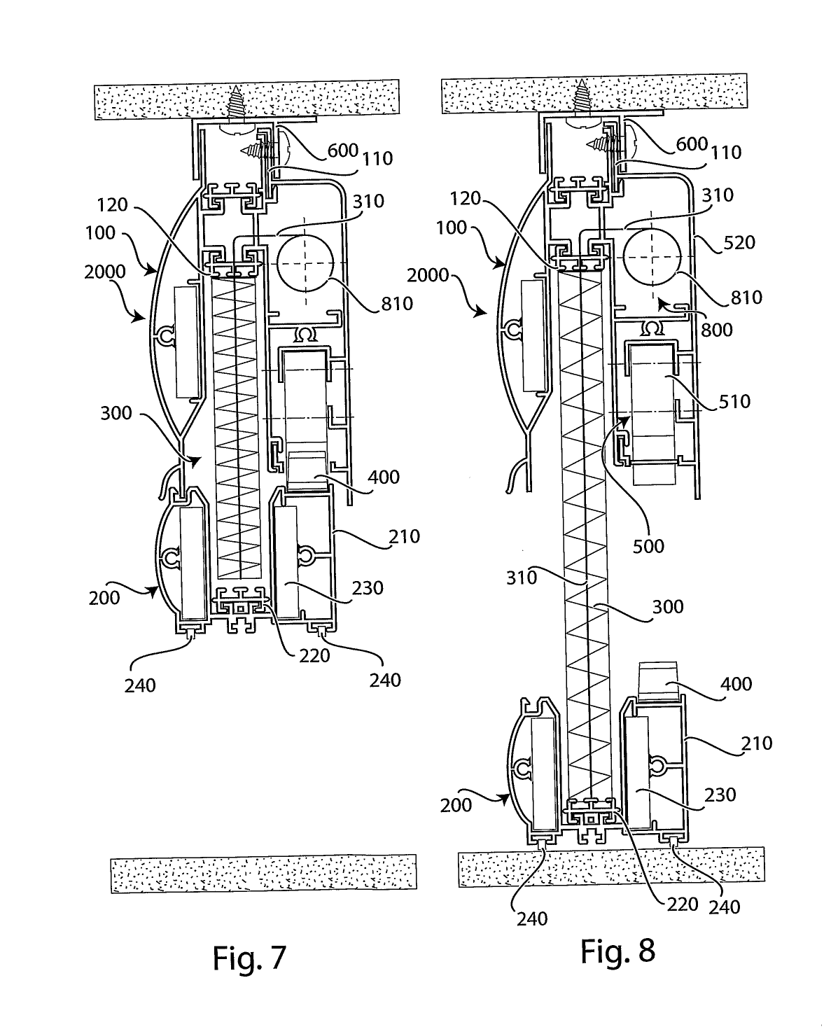

FIG. 7 shows a longitudinal sectional view of a second embodiment of the device installed and closed according to the invention;

FIG. 8 shows a longitudinal sectional view of the device of FIG. 1 installed and opened according to the invention;

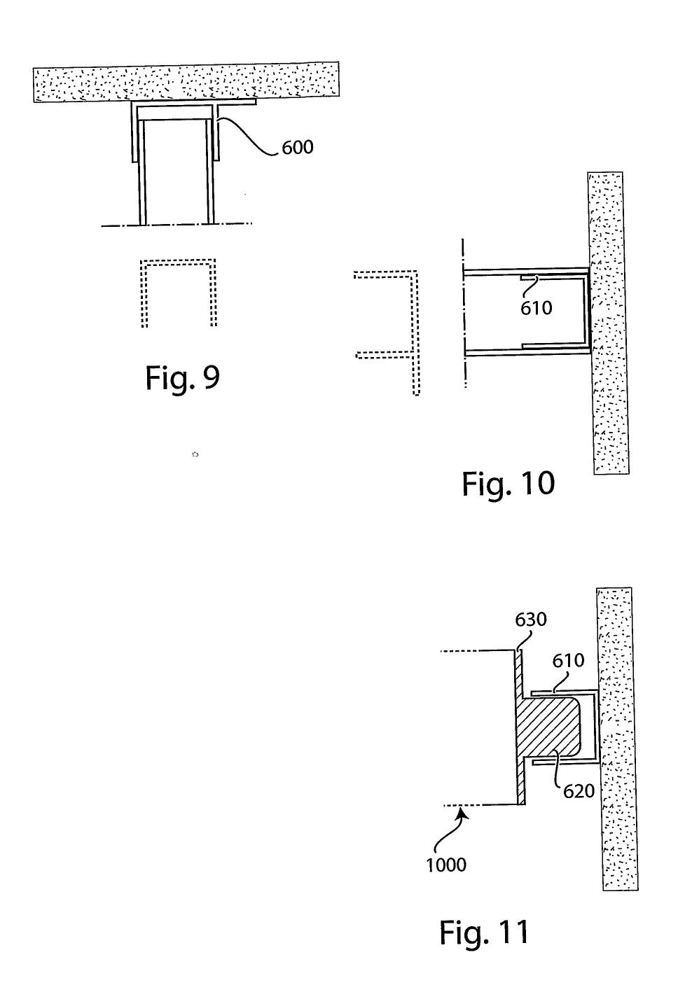

FIG. 9 shows an embodiment of the fixing upper section bar according to the invention;

FIG. 10 shows an embodiment of the lateral guide of the second embodiment of the device according to the invention;

FIG. 11 clarify the conditions of sliding of the mosquito curtain according to the invention in the lateral guide of FIG. 4;

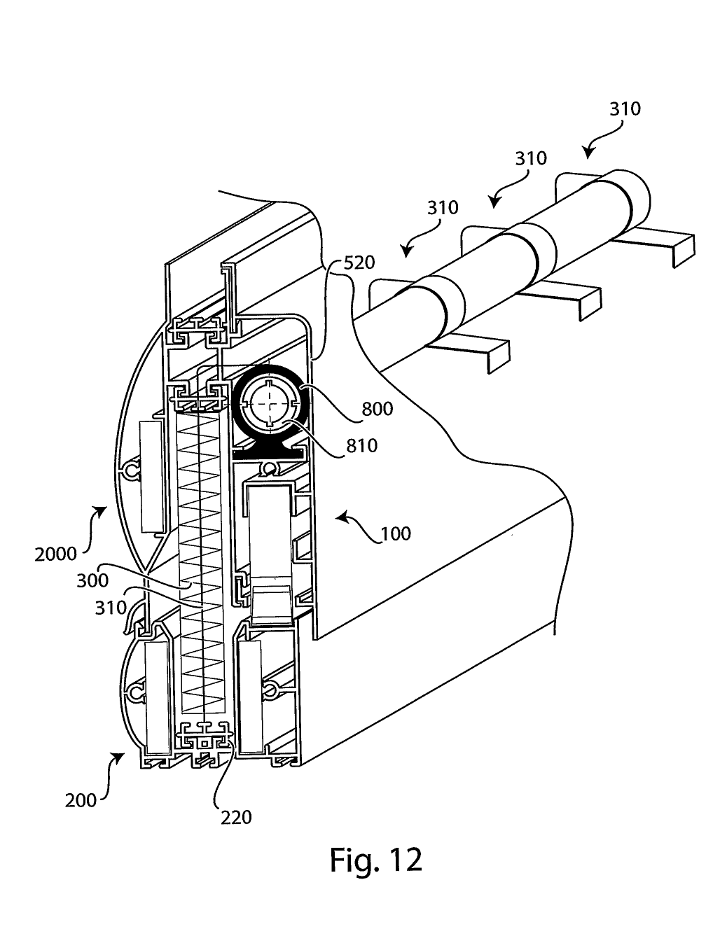

FIG. 12 shows a perspective view of a variation of the second embodiment of the mosquito curtain according to the invention.

It is immediately to be noted that, although the two main embodiments will be described each per se, the person skilled in the art may certainly combine technical elements belonging to one or the other embodiment in order to provide other embodiments or variations.

Making reference to FIG. 1, a first embodiment of the mosquito curtain 100 according to the invention comprises a first section bar 10 and a second section bar 20 between which a pleated net 30 is inserted that is connected to the internal ends 12, 22 of the same section bars 10 and 20.

On the upper portion 11 of the first section bar 10 the lower portion of the rolling shutter is hooked, whereas the lower portion 21 of the section bar 20 contains a weight 23. Laterally on the section bars, a two-part locking and unlocking system is fixed: on the section bar 20 a female device 40 is fixed, whereas the corresponding male device is fixed laterally on the section bar 10.

In such a way, when the mosquito curtain according to first embodiment of the present invention is closed, a pin 51 of the male of the locking and unlocking system 40,50,51 enters and is kept in the corresponding hole of the female part 40 of the locking system. The mosquito curtain as a whole 1000, when closed, follow naturally the vertical movement of the rolling shutter, allowing the use of the latter as usual without mosquito curtain, with the only difference of having added a lower base to the same.

When instead the mosquito curtain is not closed by means of the locking system 40,50,51, the weight 23 acts so that the section bar 20 remains on the ground whilst the section bar is drawn by the rolling shutter when this one is raised. The pleated net 30 is thus unfolded and accomplishes the task of impeding the access to mosquitoes and other insects. One or more lines 31 which cross the pleats of the pleated net 30 are provided in order to enable an guided unfolding of the same.

In the above-described example a section bar 52 is additionally comprised that covers the fittings of the system of the male 50 of the locking system, and possibly other fittings described in the following.

The locking and unlocking system 40,50,51 is preferably such that it can be operated by lowering the rolling shutter and making the mosquito curtain 1000 according to the invention beat to ground. With a first beat the unlocking is obtained, whilst with the subsequent beat one obtains the locking and so on.

Making also reference to FIG. 2, at the base of the lower part 21 of the section bar 20 a rubber part 24 can be applied with the aim of mitigating the beats needed for locking/unlocking the mosquito curtain as described above.

As mentioned, the rolling shutter is fixed to the upper end 11 of the section bar 10, for example by means of a screw-nut system 60 that passes through the stop of the rolling shutter.

Making reference to FIG. 3, the rolling shutter 70 can be fixed to the upper part 11 of the section bar 10 by using the natural hook 71 of the rolling shutter and by providing on the upper part 11 a corresponding hook means 11′, the rolling shutter being apt to be introduced or pulled horizontally.

Making now reference to FIGS. 4a and 4b, the thread (or threads) 31 passes through the pleated net and is fixed on base 22. It comes out from the section bar and is wound up thanks to a winding spring (not shown) placed in a lateral external box 80.

In FIG. 5 a section of the first embodiment of the invention device is shown with the rolling shutter hooked.

Making now reference to FIG. 6, it is possible also another different variation of the first embodiment of the invention, that does not utilise the above-described locking and unlocking system 40,50,51. Indeed, one acts directly on threads 31, winding and unwinding them in a motorised way thanks to a (electric) motor which in the case of two threads controls the winding up by means of two boxes 80 as in FIGS. 4a and 4b.

In such a way, it is not needed a specific weight 23 as in the previous embodiment variation, but the section bar 20 weight may suffice. Indeed, with rolling bar (even partially) raised, one can operate the unwinding and the gap between the rolling shutter and the ground will be filled by the net 30.

One can also provide the mosquito curtain with remote control and rechargeable battery for operating and supplying the electric motor.

Coming now to describe a second embodiment of the mosquito curtain according to the invention, with reference firstly to FIGS. 7 and 8, the mosquito curtains 2000 according to the invention comprises a first section bar 100 and a second section bar 200 between which a pleated net 300 is inserted which is connected to internal ends 120, 220 of the same section bars 100 and 200.

On the upper part 110 of the first section bar 100 a U-shape section bar 600 is fixed, which serves for the fixing to window opening, whilst the lower part 210 of the section bar 200 contains a weight 230. Laterally on the section bars a locking and unlocking system in two parts is fixed. on section bar 200 a female device 400 is fixed, whereas the corresponding male 500 is fixed laterally on section bar 100.

In such a way, when the mosquito curtain according to the invention is closed, a pin, that is inside of fittings 510 of the male part 500 of the locking and unlocking system 400,500,510, enters and is held in the corresponding hole of the female part 400 of the locking system, and allows to hook the aluminium section bars with each other, thus transforming the mosquito curtain in one body.

When instead the mosquito curtain is not closed by means of the locking and unlocking system 400,500,510, the weight 230 causes the section bar 200 to remain on the ground while the section bar 100 is drawn by the rolling bar when this is raised. The pleated net 300 is therefore unfolded and accomplishes the task of impeding the access to mosquitoes and other insects. The threads 310 that cross the pleats of the pleated net 300 are provided in order to allow a guided unfolding of the same.

In the illustrated example a section bar 520 is included as well, which covers the fittings of the system of return spring or locking fittings and possibly other fittings described in the following.

As already similarly described for the first embodiment, the locking and unlocking system 400,500,510 is such that it can be operated lowering the mosquito curtain 2000 by making it beat on the ground. With a first beat one obtains the unlocking whilst with the subsequent beat one obtains the locking and so on.

On the base of the lower part 210 of the section bar 200 one or more rubber parts 240 can be applied with the aim of deadening the beats that serve to lock/unlock the mosquito curtain as above-described.

As mentioned, the mosquito curtain is fixed to the upper end 110 of the section bar 100, for example by means of a section bar 600 fixed on the window opening beforehand.

The threads 310 pass through the pleated net and are fixed on the base 220. They comes out from the section bar and are winded up thanks to a winding mechanism 800 placed in the portion 520 of the section bar in a lateral external room, as shown in FIG. 12. Here one sees that threads 310 are all parallel one to the other and are a multiplicity, in order to allow a right and homogeneous unfolding of the pleated net 300.

It is to be noted that the winding mechanism 800 comprises an only roll 810 equipped with a spring or motorised, on which all threads 310 wind up.

In FIG. 9 the hooking to the upper frame 600 of the window opening is shown in detail, in FIG. 10 a detail of the lateral guide 610 that allows the sliding of the section bars, and in FIG. 11 an example of sliding of the section bars thanks to a plug 620 that enters in the lateral guide 610 and is connected to the mosquito curtain section bar by means of a connection 630.

Making now reference to FIG. 12 again, a different variation of the second invention embodiment is possible as well, which does not utilise the locking and unlocking system 400,500,510 above described. Indeed, one can act directly on threads 310, winding and unwinding them in a motorised way.

In such a way, it is not necessary a specific weight 230 as in the previous embodiment, but the weight of the same section bar 200 can suffice. Indeed, with (even partially) raised mosquito curtain the unwinding can be operated and the gap between the window opening and the ground will be filled by the net 300.

One can also equip the mosquito curtain with remote control and rechargeable battery for operating and supplying of the electric motor.

The mosquito curtain according to the invention (even in the first embodiment) can be mounted depending on needs on rolling shutter in PVC, aluminium, steel, by fixing end 110 of the section bar to the rolling shutter instead of to the upper fixing section bar 600.

One sees from these example embodiments how the mosquito curtain according to the invention solves the problems and overcomes the drawbacks of the prior art, in particular being of easy installation on existing rolling shutters and being suitable to be operated or not depending on needs.

The present invention has been described for illustrative but not limitative purposes, according to its preferred embodiments, but it is to be understood that modifications and/or changes can be introduced by those skilled in the art without departing from the relevant scope as defined in the enclosed claims.

1. Mosquito curtain for rolling shutters, comprising an upper section bar (10) and a lower section bar (20) and a net (30) fixed with its vertical ends to respective internal bases (12,22) of said upper section bar (10) and said lower section bar (20), in such a way that when said upper section bar (10) and said lower section bar (20) are brought in contact vertically, the net (30) is enclosed in a room delimited by them, the mosquito curtain comprising further means of reversible connection (50,51,40) of the upper section bar (10) with the lower section bar (20), the upper section bar (10) being fixable to the lower end of the rolling shutter (70), so as to follow the movement of the rolling shutter when this is moved,
the mosquito curtain being characterised in that:
the net (30) is a pleated net;
it comprises one or more guide threads (31) for the traverse of the net (30) in its extension or contraction as a consequence of the relative approaching of the upper section bar (10) and the lower section bar (20),
said one or more threads (31,310) pass through the pleated net and are fixed on an internal base (22) of the lower section bar (20);
it comprises a winding mechanism, placed in a portion (52) of the upper section bar (10), for said one or more guide threads (31,310), which wind up on an only roll.

2-26. (canceled)

27. Mosquito curtain according to claim 1 or 40, characterised in that the net (30) is a pleated net of 12 mm.

28. Mosquito curtain according to claim 1 or 27, characterised in that said one or more guide threads come out laterally (80) from the upper section bar (10), where they are returned in a lateral external room (90,80,800) by said winding mechanism.

29. Mosquito curtain according to any claim 1, 27 to 28, characterised in that the lower part of said lower section bar (20) comprises at least a housing (21) for at least a respective weight (23).

30. Mosquito curtain according to any claim 1, 27 to 29, characterised in that said means (50,51,40) of reversible connection of the upper section bar (10) with the lower section bar (20) comprise a male element (51) connected laterally to one of the two section bars, vertically insertable in a corresponding female device (40) connected on the same side laterally to the other section bar.

31. Mosquito curtain according to claim 30, characterised in that said means (50,51,40) of reversible connection are such that, by making the lower section bar (20) beat on the ground a first time, said male element (51) is locked in said corresponding female element (40), the unlocking being obtained by making the lower section bar (20) beat on the ground again.

32. Mosquito curtain according to any claim 29 to 31, characterised in that a rubber base is fixed to the lower end, which is turned to ground, of the lower section bar (20).

33. Mosquito curtain according to any claim 28 to 32, characterised in that the part (90,80) of said means of reversible connection is provided laterally on the upper section bar (10).

34. Mosquito curtain according to claim 33, characterised in that said motorised return and release means (90) comprise an electric motor, in particular that can be operated remotely.

35. Mosquito curtain according to any claim 1, 27 to 34, characterised in that the upper section bar (10) is fixable to the lower end of the rolling shutter (70) by means of a screw/nut system.

36. Mosquito curtain according to any claim 1, 27 to 34, characterised in that the upper end (11) of the upper section bar (10) presents a hooking element (11′) that can hook the corresponding hook (71) of the rolling shutter (70) that normally serves for joining two elements of the rolling shutter, said rolling shutter being fixed to the upper section bar (10) by inserting it horizontally along said hooking element (11′).

37. Mosquito curtain according to any claim 1, 27 to 36, characterised in that said winding mechanism (800) comprises return elastic means, such as a return spring.

38. Mosquito curtain system, characterised in that it comprises:
a mosquito curtain according to any claim 1, 27 to 37;
fixing means for fixing the mosquito curtain to the upper wall of the window opening;
vertical sliding guides (610) fixable to window opening, laterally to said lower section bar (200) and/or upper section bar (100) being provided one or more lateral guide means (620) of the section bar suited to slide into said vertical sliding guides.

39. Mosquito curtain system according to claim 38, characterised in that said at least a respective lateral guide element (620) is part of a lateral “plug” (620,630) of the lower section bar (200) and/or of the upper section bar (100).

40. Mosquito curtain for rolling shutters, comprising an upper section bar (10) and a lower section bar (20) and a net (30) fixed with its vertical ends to respective internal bases (12,22) of said upper section bar (10) and said lower section bar (20), in such a way that when said upper section bar (10) and said lower section bar (20) are brought in contact vertically, the net (30) is enclosed in a room delimited by them, the mosquito curtain comprising further means of reversible connection (50,51,40) of the upper section bar (10) with the lower section bar (20), the upper section bar (10) being fixable to the lower end of the rolling shutter (70), so as to follow the movement of the rolling shutter when this is moved, the mosquito curtain further comprising:
the net (30), which is a pleated net;
one or more guide threads (31) for the traverse of the net (30) in its extension or contraction as a consequence of the relative approaching of the upper section bar (10) and the lower section bar (20);
said one or more threads (31,310) passing through the pleated net and fixed on an internal base (22) of the lower section bar (20);
a winding mechanism, placed in a portion (52) of the upper section bar (10), for said one or more guide threads (31,310), which wind up on an only roll.
